(19) United States
(12) Patent Application Publication
(10) Pub. No.: US 2024/0303662 A1
(43) Pub. Date: Sep. 12, 2024

(54) FRAUD DETECTION IN NFT EXCHANGES

(71) Applicant: ADOBE INC., SAN JOSE, CA (US)

(72) Inventors: Raunak Shah, Wagholi (IN); Harshvardhan ., Bokaro Steel City (IN); Mohit Kumar, Bathinda (IN); Shambhavi Pardhi, Balaghat (IN); Alakh Dixit, Indore (IN); Shaddy Garg, Baghapurana (IN); Shiv Kumar Saini, Bangalore (IN); Ramasuri Narayanam, Bangalore (IN)

(21) Appl. No.: 18/181,018

(22) Filed: Mar. 9, 2023

(51) Int. Cl. G06Q 20/40; G06Q 20/38

(52) U.S. Cl. CPC G06Q 20/4016; G06Q 20/389

(57) ABSTRACT

Systems and methods for identifying fraudulent activity in NFT exchanges are described. Embodiments of the present disclosure obtain transaction data for non-fungible tokens (NFTs) and generate a transaction graph based on the transaction data. The transaction graph includes nodes corresponding to blockchain addresses and nodes corresponding to individual NFTs. Embodiments additionally identify a cycle of the transaction graph, predict a fraudulent activity based on the cycle using a machine learning model, and transmit an alert to a user indicating the predicted fraudulent activity.

### BACKGROUND

The following relates generally to fraud detection, and more specifically to identifying fraudulent activity among non-fungible tokens (NFTs).

NFTs are digital assets that are authenticated using blockchain technology. They can be used as proof of ownership of various items, including artwork and collectibles. Blockchains, and the protocols and exchanges built on top of the blockchains, can exist without being centrally controlled. This decentralization increases the availability of digital assets to consumers, but can also avail bad actors of fraudulent mechanisms. Many micro-level factors, such as individual trades and their timing, can enable macro level changes such as changes in pricing and sentiment. This behavior can undermine the credibility of buyers, sellers, and the blockchain as a whole.

### SUMMARY

Embodiments include a fraud detection apparatus configured to extract fraud indicator features related to an NFT. In some examples, the fraud detection apparatus creates knowledge graphs such as a trader-trader network and a trader-NFT network from a transaction history. Then, the apparatus computes features from the graphs, and generates a score that indicates an extent a selected NFT is involved in fraudulent activity. Some embodiments further predict a future exchange rate of the NFT, as well as an exchange rate of the NFT if it were removed from the fraudulent activity.

A method, apparatus, non-transitory computer readable medium, and system for identifying fraudulent activity in non-fungible token (NFT) exchanges are described. One or more aspects of the method, apparatus, non-transitory computer readable medium, and system include obtaining transaction data for non-fungible tokens (NFTs); generating, using a graph component, a transaction graph based on the transaction data, wherein the transaction graph includes nodes corresponding to blockchain addresses and nodes corresponding to individual NFTs; identifying, using a cycle component, a cycle of the transaction graph; predicting, using a machine learning model a fraudulent activity based on the cycle; and transmitting an alert indicating the predicted fraudulent activity.

A method, apparatus, non-transitory computer readable medium, and system for identifying fraudulent activity in NFT exchanges are described. One or more aspects of the method, apparatus, non-transitory computer readable medium, and system include obtaining training data including transaction data for non-fungible tokens (NFTs); generating, using a graph component a transaction graph based on the transaction data, wherein the transaction graph includes nodes corresponding to blockchain addresses and nodes corresponding to individual NFTs; identifying, using a cycle component, a cycle of the transaction graph; and training, using a training component, a machine learning model to predict a fraudulent activity based on the cycle and the training data.

An apparatus, system, and method for identifying fraudulent activity in NFT exchanges are described. One or more aspects of the apparatus, system, and method include a processor and a memory including instructions executable by the processor to: obtain transaction data for non-fungible tokens (NFTs); generate, using a graph component, a transaction graph based on the transaction data, wherein the transaction graph includes nodes corresponding to blockchain addresses and nodes corresponding to individual NFTs; identify, by a cycle component, a cycle of the transaction graph; predict, using a machine learning model, a fraudulent activity based on the cycle; and transmit an alert indicating the predicted fraudulent activity.

### BRIEF DESCRIPTION OF THE DRAWINGS

FIG. 1 shows an example of a fraud detection system according to aspects of the present disclosure.

FIG. 2 shows an example of a fraud detection apparatus according to aspects of the present disclosure.

FIG. 3 shows an example of a trader-trader network according to aspects of the present disclosure.

FIG. 4 shows an example of a trader-NFT network according to aspects of the present disclosure.

FIG. 5 shows an example of a method for identifying fraudulent activity according to aspects of the present disclosure.

FIG. 6 shows an example of a method for indicating fraudulent activity to a user according to aspects of the present disclosure.

FIG. 7 shows an example of a method for extracting non-intersecting cycles according to aspects of the present disclosure.

FIG. 8 shows an example of a method for predicting fraudulent activity based on multiple fraud indicator features according to aspects of the present disclosure.

FIG. 9 shows an example of a method for training a machine learning model to predict fraudulent activity according to aspects of the present disclosure.

FIG. 10 shows an example of a computing device according to aspects of the present disclosure.

### DETAILED DESCRIPTION

According to some aspects, a fraud detection system includes a graph component, a cycle component, a machine learning model, and a user interface. In some aspects, the fraud detection system obtains transaction data for NFTs, and generates a transaction graph based on the transaction data. According to some aspects, the transaction graph includes nodes corresponding to NFTs and to blockchain addresses. The cycle component then identifies a cycle based on the transaction graph. In some embodiments, one or more features are extracted from the cycle, and then the one or more features are input to the machine learning model. In some embodiments, the cycle is input to the machine learning model directly. The machine learning model then predicts a fraudulent activity based on the cycle. An alert indicating the predicted fraudulent activity is then transmitted to an endpoint, such as a user interface. By predicting a fraudulent activity based on transaction cycles, the machine learning model is able to alert buyers of potential fraud, thereby allowing them to make informed decisions.

In one example, a user wishes to acquire one or more NFTs by shopping on a marketplace. The fraud detection system can be enabled on the user-side or on the marketplace proprietor side. The user browses the marketplace, and identifies an NFT that they are interested in. The fraud identification system then searches a transaction graph to identify transactions that include the NFT. The fraud identification system then performs an algorithm on the transaction list to extract non-intersecting cycles that include the NFT. Then the system extracts various features from the cycles, and processes the features using a machine learning model to compute a value indicating the predicted severity of the NFT's involvement in fraudulent activity. The fraud identification system then presents the value to the user, and they can then make an informed decision on whether to purchase the NFT.

As used herein, “transaction data” refers to the transaction histories of NFTs and blockchain addresses. The data can include time-stamped transactions that include a buyer, a seller, an amount of cryptocurrency, and other data. In some cases, this data is extracted from one or more blockchain data structures.

As used herein, a “transaction graph” is a transformation of the transaction data into a graph representation which includes nodes, edges, and weights. In some embodiments, the transaction graph is a bipartite graph that includes two types of nodes: NFTs and blockchain addresses. The blockchain addresses correspond to “wallets” of individual users, organizations, etc. In some embodiments, the graph is stored in the form of one or more matrices.

As used herein, a “cycle” is an ordered list of blockchain addresses that have transacted a particular NFT, such that the list begins and ends with the same blockchain address. In some examples, the fraud identification system is configured to identify non-intersecting cycles.

Examples of fraudulent activity include wash trading and money laundering. The goal of wash trading activities is to artificially inflate an NFT's exchange rate through collusion to create a false and/or unstable valuation of the NFT. Money laundering activities include the use of several rapid transactions to illegally transfer money between accounts. In some cases, the rapid transactions obfuscate the true actors behind the trades.

An NFT is a unique digital identifier that cannot be duplicated, split, or substituted, that is recorded in a blockchain. NFTs are typically used to certify authenticity and ownership of an asset, such as digital art. Since ownership of the NFT is recorded on the blockchain, ownership can be transferred using the same processes as sending cryptocurrency on the blockchain, allowing for NFT trading.

NFTs are often traded on marketplaces, which can be referred to as “exchanges.” Exchanges provide a platform for sellers to connect with buyers, and vice-versa. Many of these exchanges allow buyers to buy with cryptocurrencies, which are generally not subjected to the regulations of fiat currencies. Cryptocurrencies and NFTs are exchanged using blockchain technology, as opposed to centralized systems such as banks. Accordingly, each transaction is validated according to the built-in protocols of the blockchain technology used, along with any additional protocols provided by the exchanges, rather than through a centralized authority.

In some cases, the validation measures provided by blockchain technology and exchanges are unable to identify and measure the effects of fraudulent trades. For example, the blockchain technology can implement proof-of-work or proof-of-stake authentication to ensure the transaction information itself was not fabricated, but it might not identify repeated transactions for the same asset, the speed of transactions, or the like. Further still, the exchanges are usually frontends to the blockchain and any security measures are generally inherited without implementing additional ones.

Various factors influence the exchange rates of NFTs. In some cases, computer models are used to predict the effects of Bitcoin and Ethereum shocks over NFT sales. Other techniques extract features from transaction histories of NFTs to try to generate predictions on NFT pricing. However, these methods do not identify fraudulent activity, nor quantify the fraudulent activity for its extent or effect on NFT pricing.

Embodiments of the present disclosure include a fraud identification apparatus configured to identify fraudulent activity by extracting fraud indicator features from an NFT transaction history. In some examples, the fraud identification apparatus generates a credibility score that indicates the extent an NFT is involved in fraud. Some examples additionally generate a credibility score for the current seller of the NFT.

Embodiments of the apparatus were trained using a causal forest model to identify an average treatment effect (ATE) of each of the fraud indicator features, which quantifies their relative effects on an NFT. For example, some fraud indicator features are experimentally determined to have a greater effect on an NFT's exchange rate than others. Accordingly, some embodiments additionally estimate the likelihood of the NFT's exchange rate being currently affected by the fraudulent activity. In this way, embodiments increase the credibility of NFT exchanges, and can provide users with insights to make informed decisions in the exchange.

Accordingly, embodiments described herein provide users with indications of suspected fraudulent activity. This allows users to shop on NFT exchanges with increased confidence and knowledge, thereby providing an improved shopping experience and preventing the user from becoming a victim of fraud.

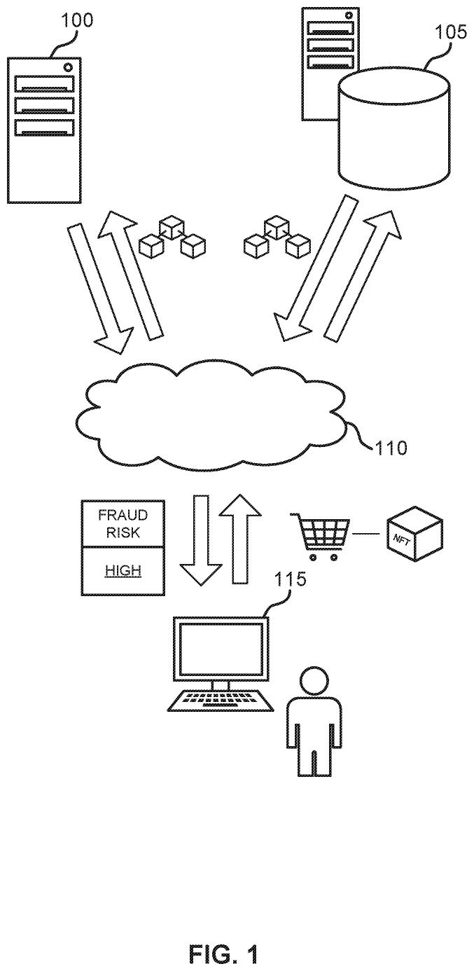

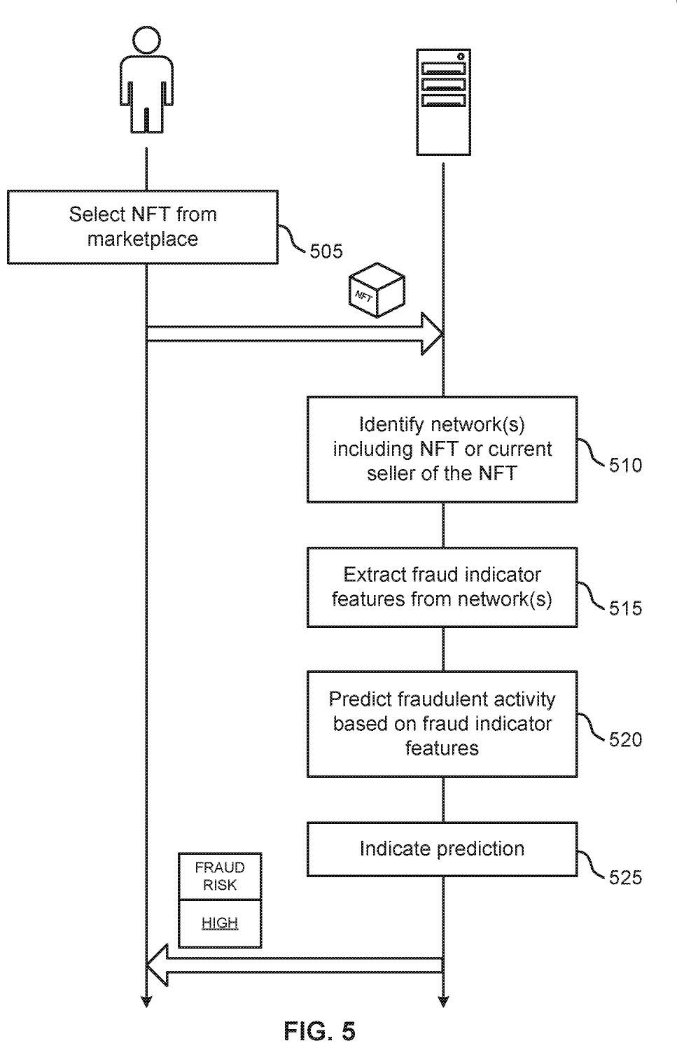

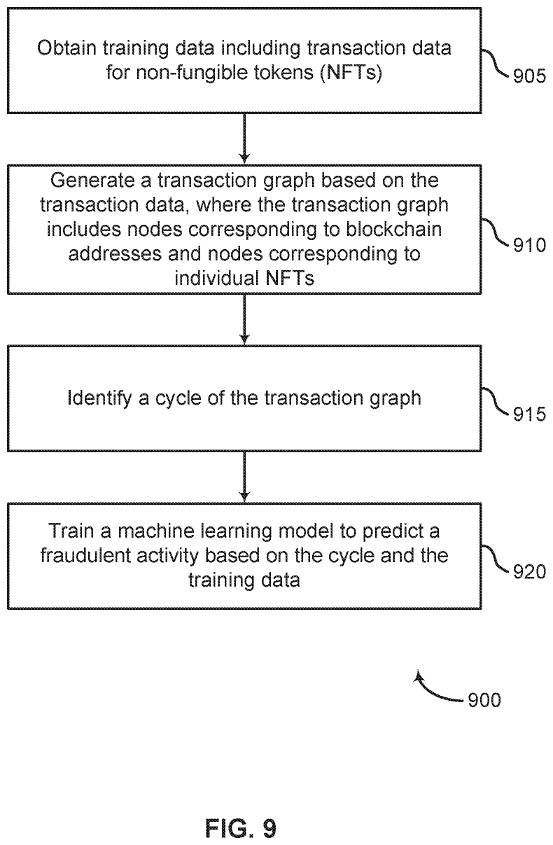

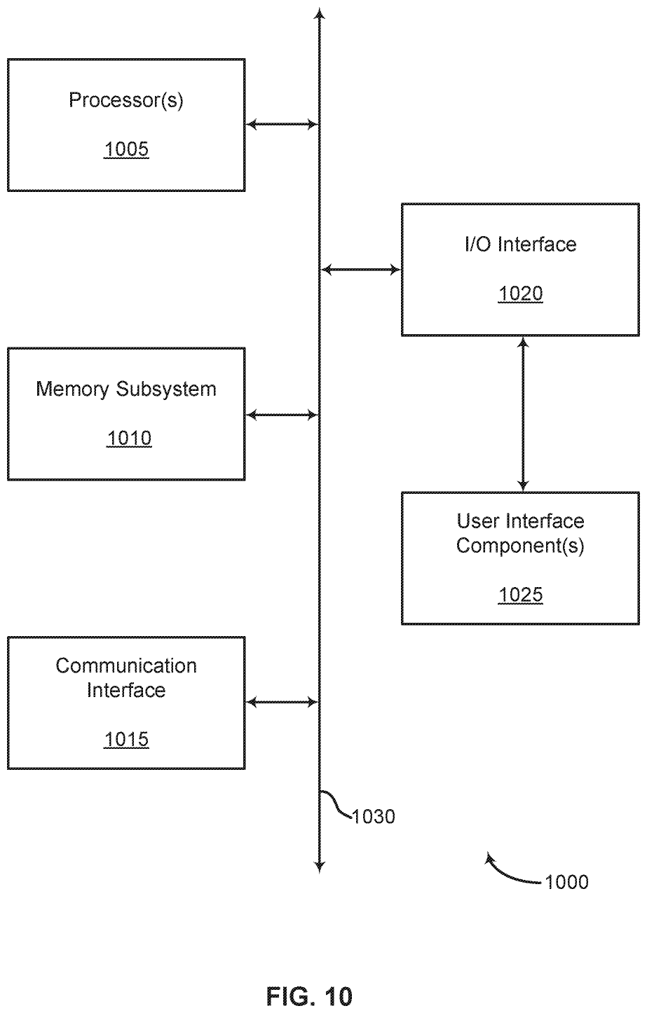

A fraud identification system is described with reference to FIGS. 1-4. Methods for identifying fraud and providing an indication to a user are described with reference to FIGS. 5-8. A method for training the fraud identification system is described with reference to FIG. 9. A computing device configurable to implement a fraud identification apparatus is described with reference to FIG. 10.

### Fraud Identification System

An apparatus for identifying fraudulent activity in NFT exchanges is described. One or more aspects of the apparatus include a processor and a memory including instructions executable by the processor to: obtain transaction data for NFTs; generate, using a graph component, a transaction graph based on the transaction data, wherein the transaction graph includes nodes corresponding to blockchain addresses and nodes corresponding to individual NFTs; identify, by a cycle component, a cycle of the transaction graph; predict, using a machine learning model, a fraudulent activity based on the cycle; and transmit an alert indicating the predicted fraudulent activity. In some aspects, the machine learning model is trained to predict an NFT exchange rate.

Some examples of the apparatus, system, and method further include a training component configured to train a machine learning model to predict the fraudulent activity based on the cycle. Some examples further include a transaction component configured to compute a rapid transaction score based on the transaction data. Some examples further include a ranking component configured to predict a node ranking of a node in the transaction graph, based on the transaction graph. In some aspects, the cycle component is configured to compute a number of cycles, a harmonic sum of cycle length, or a combination thereof based on the transaction graph.

FIG. 1 shows an example of a fraud detection system according to aspects of the present disclosure. The example shown includes fraud detection apparatus 100, database 105, network 110, and user interface 115. According to some aspects, some features or components of fraud detection apparatus 100 are implemented on a machine local to a user, and others are implemented on machines that are remote with respect to the user.

In some examples, fraud detection apparatus 100 obtains transaction data for NFTs from a blockchain or an exchange. In some examples, the data is stored on database 105. Then, fraud detection apparatus 100 generates a transaction graph from the transaction data, where nodes of the graph correspond to blockchain addresses (e.g., corresponding to wallets) and individual NFTs. In some examples, copies of the transaction graph are maintained on the database 105 and fraud detection apparatus 100. According to some aspects, fraud detection apparatus 100 then computes features from the transaction graph, such as a buying-selling cycle of an NFT. Fraud detection apparatus 100 identifies an extent of fraudulent activity based on the features, and provides an indication of the fraudulent activity to a user through user interface 115.

Embodiments of fraud identification apparatus 100 include several components. The term ‘component’ is used to partition the functionality enabled by the processors and the executable instructions included in the computing device used to implement fraud identification apparatus 100 (such as the computing device described with reference to FIG. 10). The partitions can be implemented physically, such as through the use of separate circuits or processors for each component, or can be implemented logically via the architecture of the code executable by the processors.

In some examples, one or more components of fraud detection apparatus 100 are implemented on a server. A server provides one or more functions to users linked by way of one or more of the various networks 110. In some cases, the server includes a single microprocessor board, which includes a microprocessor responsible for controlling all aspects of the server. In some cases, a server uses microprocessor and protocols to exchange data with other devices/users on one or more of the networks 110 via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Various data used and processed by fraud detection apparatus 100 is stored in database 105. Examples of such data include transaction histories, knowledge graphs (e.g., data structures which encode the knowledge graphs), blockchain data, NFT data, and training data. In some cases, database 105 includes data storage, as well as a server to manage disbursement of data and content. A database is an organized collection of data. For example, a database stores data in a specified format known as a schema. A database can be structured as a single database, a distributed database, multiple distributed databases, or an emergency backup database. In some cases, a database controller manages data storage and processing in database 105. In some cases, a user interacts with the database controller. In other cases, the database controller operates automatically without user interaction.

Network 110 facilitates the transfer of information between fraud detection apparatus 100, database 105, and user interface 115 (e.g., to a user). Network 110 can be referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 is configured to present content to a user, and to receive user input. Embodiments of user interface 115 include a display, input means such as a mouse and keyboard or touch screen, speakers, and the like. In example examples, a user selects an NFT from an exchange using user interface 115. According to some aspects, user interface 115 transmits an alert indicating predicted fraudulent activity related to the NFT.

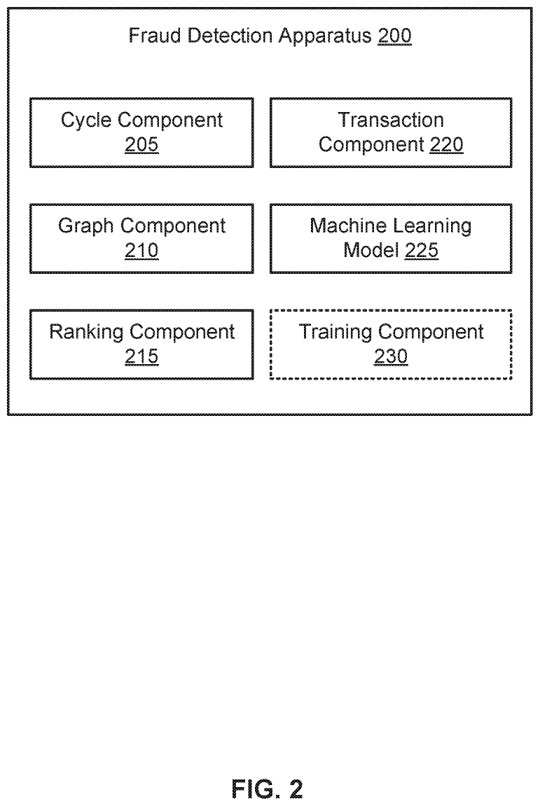

FIG. 2 shows an example of a fraud detection apparatus 200 according to aspects of the present disclosure. Fraud detection apparatus 200 is an example of, or includes aspects of, the corresponding element described with reference to FIG. 1.

As mentioned above, fraud detection apparatus 200 includes several components. The term ‘component’ is used to partition the functionality enabled by the processors and the executable instructions included in the computing device used to implement fraud detection apparatus 200 (such as the computing device described with reference to FIG. 10). The partitions can be implemented physically, such as through the use of separate circuits or processors for each component, or can be implemented logically via the architecture of the code executable by the processors. The example of fraud detection apparatus 200 shown in FIG. 2 includes cycle component 205, graph component 210, ranking component 215, transaction component 220, machine learning model 225, and training component 230.

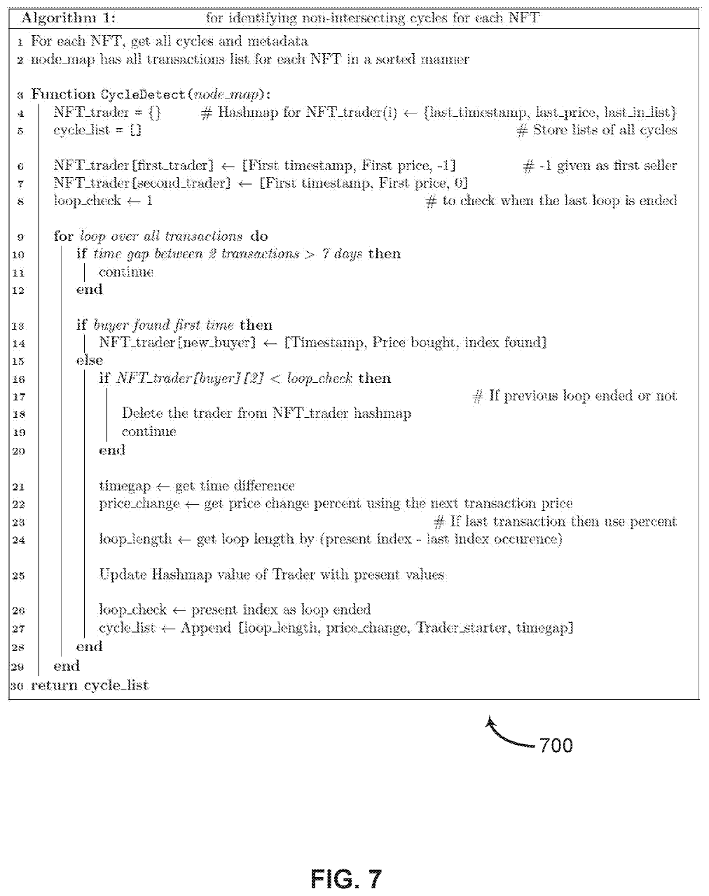

Cycle component 205 is configured to identify non-intersecting transaction cycles for an NFT, as well as to compute features related to cycles for the NFT. In some aspects, the features include “number of cycles”, and “harmonic sum length of cycles”. Additional detail regarding computing the features will be provided with reference to FIG. 7.

According to some aspects, cycle component 205 identifies a cycle of the transaction graph. In some examples, cycle component 205 computes a number of cycles based on the transaction graph, where fraudulent activity is predicted based on the number of cycles. In some examples, cycle component 205 computes a harmonic sum of cycle length based on the transaction graph, where fraudulent activity is predicted based on the harmonic sum of cycle length.

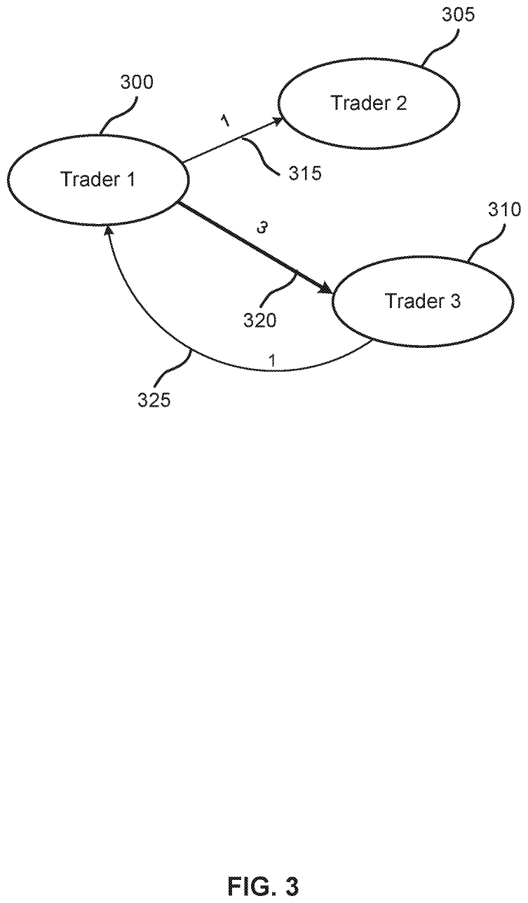

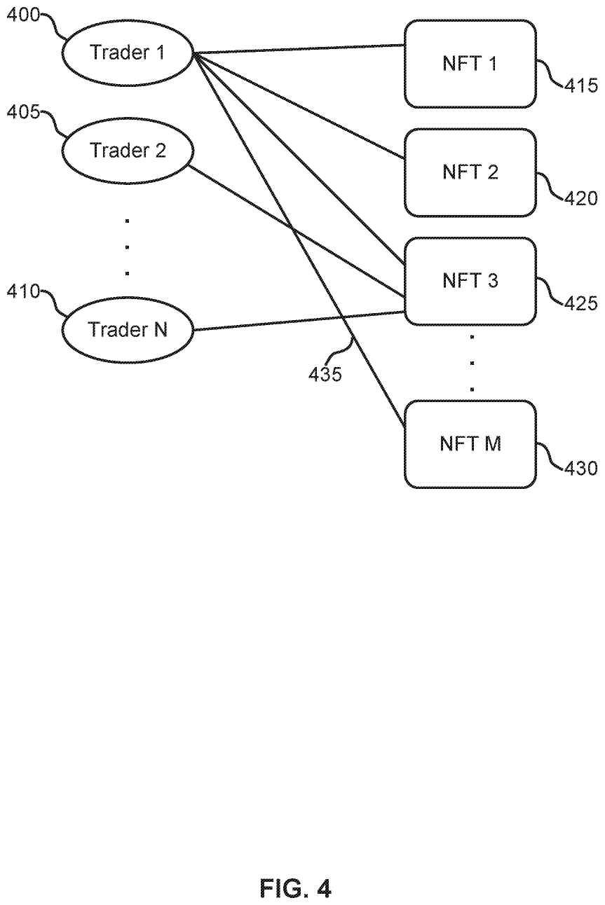

Graph component 210 is configured to initialize knowledge graphs based on transaction data. The knowledge graphs include a trader-trader network, which will be described in greater detail with reference to FIG. 3, and a trader-NFT network, which will be described in greater detail with reference to FIG. 4. In the context of such graphs, the term “network” is synonymous with “knowledge graph”.

According to some aspects, graph component 210 generates a transaction graph based on the transaction data, where the transaction graph includes nodes corresponding to blockchain addresses and nodes corresponding to individual NFTs. In some examples, graph component 210 generates an edge of the transaction graph between a first node corresponding to a first blockchain address and a second node corresponding to a second blockchain address based on a transfer of an NFT from the first blockchain address to the second blockchain address. In an example, the edge is a directed edge, corresponds to the number of times the first blockchain address has purchased an NFT before the second blockchain address has purchased the same NFT, where the first blockchain address is an originating node and the second blockchain address is a target node. In some examples, graph component 210 generates an edge of the transaction graph between a first node corresponding to a first blockchain address and a second node corresponding to an NFT based on a transfer of the NFT to or from the first blockchain address.

Ranking component 215 is configured to compute ranking related features for an NFT or a blockchain address based on the graphs generated from graph component 210. Some examples of the ranking related features include a Page Rank, a BiRank, and various measures of centrality. According to some aspects, ranking component 215 computes a node ranking based on the transaction graph, and fraudulent activity is predicted based on the node ranking.

Transaction component 220 is configured to compute another fraud indicator feature referred to as a “rapid transaction score”. The rapid transaction score is a measure of the effect of rapid transactions on an NFT, which can indicate fraudulent activity such as money laundering. The metric incorporates a number of traders involved in a series of transactions, an absolute exchange rate change of the NFT, and the time taken during the series of transactions. According to some aspects, transaction component 220 computes the rapid transaction score based on the transaction data, and the fraudulent activity is predicted based on the rapid transaction score. Additional detail, including the formula used to compute the rapid transaction score, will be provided with reference to FIG. 7.

Machine learning model 225 is configured to process the features generated by cycle component 205, ranking component 215, and transaction component 220 to predict the extent an NFT is involved in fraudulent activity. Embodiments of machine learning model 225 additionally predict an exchange rate of the NFT. In some embodiments, machine learning model 225 predicts the exchange rate of an NFT using regression techniques.

Regression is a technique that is used to identify relationships between independent variables and dependent variables. Outcomes (e.g., values of the dependent variables) can then be predicted once the relationships between independent and dependent variables have been estimated. In machine learning, various parameters are adjusted during a training phase to fit a regression model between variables. For example, a machine learning component as described herein leans relationship(s) between transaction activity and the exchange rate of an NFT. In some aspects, the machine learning model 225 is trained to predict an NFT exchange rate using fitted regression models. In some examples, machine learning model 225 predicts a value of an NFT during an inference period using the transaction data.

Training component 230 is configured to adjust parameters of fraud detection apparatus 200 to increase fraud detection accuracy and to increase exchange rate prediction accuracy of fraud detection apparatus 200. In some examples, training component 230 is implemented on an apparatus different than fraud detection apparatus 200.

According to some aspects, training component 230 trains a machine learning model 225 to predict a fraudulent activity based on the cycle and the training data. In some examples, training component 230 divides the transaction data into a first period and a second period, where the machine learning model 225 is trained based on the transaction data from the first period and is evaluated based on the transaction data from the second period. In some examples, training component 230 trains the machine learning model 225 to predict an NFT exchange rate based on the training data. In some aspects, the machine learning model 225 is trained based on a causal forest learning method. Additional detail regarding training is provided with reference to FIG. 9.

FIG. 3 shows an example of a trader-trader network according to aspects of the present disclosure. The example shown includes trader 1 300, trader 2 305, trader 3 310, first edge 315, second edge 320, and third edge 325.

The trader-trader network is a knowledge graph that is created and updated by, for example, a graph component as described with reference to FIG. 2. The trader-trader network can be implemented in several different ways. In one example, the trader-trader network is implemented such that a directed edge from a first trader to a second trader indicates the first trader has sold an NFT to the second trader. In this example, a weight of the edge can indicate how many times the first trader has sold an NFT to the second trader.

In the example shown in FIG. 3, a directed edge from a first trader to a second trader indicates that the first trader has purchased an NFT before the second trader has purchased the same NFT. In the example shown, trader 1 300 purchased an NFT one time before trader 2 305 purchased that same NFT, as indicated by the weight ‘1’ of first edge 315. Trader 1 300 purchased three NFTs before trader 3 310 purchased those three NFTs, as indicated by the weight ‘3’ of second edge 320. Trader 3 310 purchased an NFT one time before trader 1 300 purchased that same NFT, as indicated by the weight ‘1’ of third edge 325.

A trader-trader graph as used in practice can contain hundreds of thousands nodes representing hundreds of thousands of traders, with many edges connecting them. Features extracted from the trader-trader graph can offer insight about the influence of one trader over another trader in the exchange. Examples of network-level (i.e., graph) features will be described with reference to FIG. 4.

FIG. 4 shows an example of a trader-NFT network according to aspects of the present disclosure. The example shown includes trader 1 400, trader 2 405, trader N 410, NFT 1 415, NFT 2 420, NFT 3 425, NFT M 430, and edge 435.

In this example, there are N trader nodes and M NFT nodes. The graph is a “bipartite graph” due to its inclusion of two different types of nodes. The trader-NFT network of FIG. 4 is implemented such that an edge exists between a trader and an NFT if the trader has purchased that NFT. In some embodiments, the edge includes a weight. In some cases, the weight represents how many times the trader has bought the NFT (e.g., indicates the trader has repeatedly bought and sold the NFT).

In the example shown, trader 1 400 has purchased NFT 1 415, NFT 2 420, NFT 3 425, and NFT M 430. Trader 2 405 has purchased NFT 3 425. In an example, trader 2 405 has purchased NFT 3 425 and subsequently sold NFT 3 425 before NFT 3 425 was purchased by trader 1 415. Similarly, trader N 430 could have bought NFT 3 425 from, for example, trader 1 400 or trader 2 405.

The trader-trader network described with reference to FIG. 3 and the trader-NFT network described with reference to FIG. 4 store salient information pertaining to an NFT transaction history. A fraud detection apparatus as described with reference to FIG. 2 is configured to extract features from both networks, which can be used to predict fraudulent activity or the exchange rate of an NFT. Examples of such features are provided below in Table 1.

TABLE 1
Network-features extracted from Trader-NFT network

| Feature | | Exchange | |
|---|---|---|---|
| Name | Feature Description | Entities | Extracted From |
| Degree | Number of edges for a | NFT | Trader-NFT |
| Centrality | particular node | | network |
| | | Traders | Trader-Trader |
| | | | network |
| In-Degree | Number of incoming edges | NFT | Trader-NFT |
| Centrality | for a particular | | network |
| | Node | Traders | Trader-Trader |
| | | | network |
| Out-Degree | Number of outcoming edges | NFT | Trader-NFT |
| Centrality | for a particular | | network |
| | Node | Traders | Trader-Trader |
| | | | network |
| PageRank | | NFT | Trader-NFT |
| | | | network |
| | | Traders | Trader-Trader |
| | | | network |
| BiRank | | NFT | Trader-NFT |
| | | | network |
| | | Traders | Trader-Trader |
| | | | network |
| Louvain | Cluster Size using Louvain | NFT | Trader-NFT |
| Clustering | modularity Technique | | network |
| | | Traders | Trader-Trader |
| | | | network |

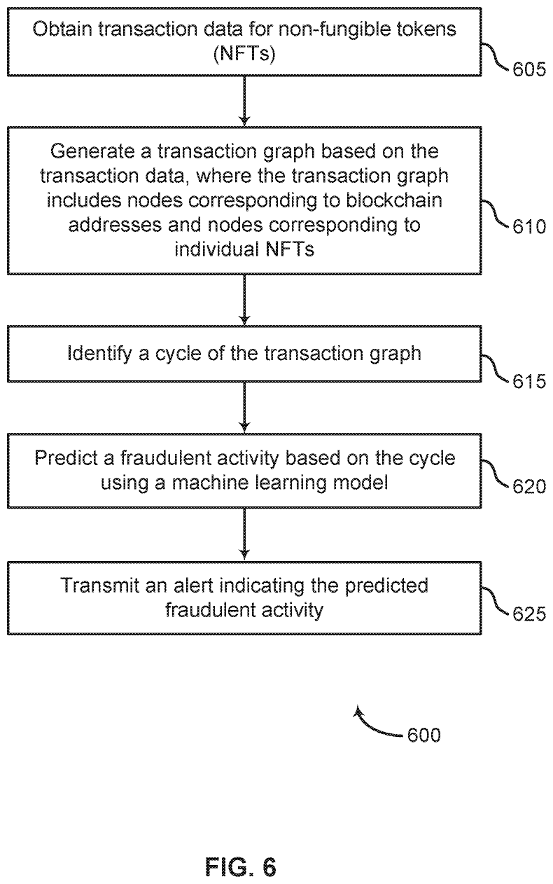

The network level features above are extracted using a ranking component as described with reference to FIG. 2. The PageRank and BiRank features can be extracted using various algorithms known in the art. In some cases, the features above are used by a machine learning model to predict the exchange rate of an NFT at some point in the future. In some cases, the features in Table 1 are used by the machine learning model in combination with fraud indicator features to predict a “corrected” exchange rate for the NFT, e.g. the predicted exchange rate of the NFT without the effects of fraudulent activity. Additional detail regarding the fraud indicator features will be described with reference to FIG. 6.

### Predicting Fraudulent Activity

A method for identifying fraudulent activity in non-fungible token (NFT) exchanges is described. One or more aspects of the method include obtaining transaction data for non-fungible tokens (NFTs); generating a transaction graph based on the transaction data, wherein the transaction graph includes nodes corresponding to blockchain addresses and nodes corresponding to individual NFTs; identifying a cycle of the transaction graph; predicting a fraudulent activity based on the cycle using a machine learning model; and transmitting an alert indicating the predicted fraudulent activity.

Some examples of the method, apparatus, non-transitory computer readable medium, and system further include generating an edge of the transaction graph between a first node corresponding to a first blockchain address and a second node corresponding to a second blockchain address based on a transfer of an NFT from the first blockchain address to the second blockchain address. In some embodiments, this operation is performed by a graph component as described with reference to FIG. 2, and can be performed during the creation of a trader-trader graph as described with reference to FIG. 3.

Some examples of the method, apparatus, non-transitory computer readable medium, and system further include generating an edge of the transaction graph between a first node corresponding to a first blockchain address and a second node corresponding to an NFT based on a transfer of the NFT to or from the first blockchain address. In some embodiments, this operation is performed by a graph component as described with reference to FIG. 2, and can be performed during the creation of a trader-NFT graph as described with reference to FIG. 4.

Some examples of the method, apparatus, non-transitory computer readable medium, and system further include computing a number of cycles based on the transaction graph, wherein the fraudulent activity is predicted based on the number of cycles. Some examples further include computing a harmonic sum of cycle length based on the transaction graph, wherein the fraudulent activity is predicted based on the harmonic sum of cycle length.

Some examples of the method, apparatus, non-transitory computer readable medium, and system further include computing a node ranking based on the transaction graph, wherein the fraudulent activity is predicted based on the node ranking. Some examples further include computing a rapid transaction score based on the transaction data, wherein the fraudulent activity is predicted based on the rapid transaction score.

Some examples of the method, apparatus, non-transitory computer readable medium, and system further include predicting a value of an NFT based on the transaction data. Some examples include limiting transactions on an NFT trading platform based on the predicted fraudulent activity. Some examples further include performing a transaction on a blockchain based on the predicted fraudulent activity. In an example, embodiments reject a transaction or automatically complete a scheduled transaction based on the predicted fraudulent activity.

FIG. 5 shows an example of a method 500 for identifying fraudulent activity according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, a user selects an NFT from an NFT exchange. In one example, the user controls a local machine through a user interface. In an example, the user interacts with a graphical user interface (GUI), which includes a desktop application or a web-based application. The user interacts with the GUI to select an NFT from the exchange.

At operation 510, the system identifies network(s) including the NFT or the current seller of the NFT. The network(s) include knowledge graphs, as described above with reference to FIGS. 2-4. In an example, a graph component of the system has previously digested a transaction history of the NFT and created a trader-NFT network that includes information about the NFT's relation to traders. In some examples, the graph component identifies the transaction history by accessing the blockchain of the NFT. In some examples, the graph component identifies the transaction history from the exchange that lists the NFT.

At operation 515, the system extracts fraud indicator features from network(s). For example, various components of the system including a cycle component, a transaction component, and a ranking component can create features based on the information contained in the network(s). In some embodiments, the transaction component processes the transaction history before the transaction history has been encoded into the network(s). Additional detail regarding fraud indicator features will be provided with reference to FIG. 7.

At operation 520, the system predicts fraudulent activity based on fraud indicator features. The fraud indicator features can include a harmonic sum of cycle length, a number of cycles, other features, or a combination thereof. In some examples, the system learns to identify different weights for each fraud indicator feature, where the weights indicate the feature's effect on an NFT's exchange rate.

At operation 525, the system indicates the prediction of the fraudulent activity. In an embodiment, the system presents an alert to the user indicating a relatively high probability that the selected NFT is involved in fraud. In one embodiment, the system computes a “credibility score” that indicates the extent or the likelihood that the selected NFT is involved in fraud, and displays the credibility score to the user.

FIG. 6 shows an example of a method 600 for indicating fraudulent activity to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains transaction data for non-fungible tokens (NFTs). In some cases, the operations of this step refer to, or are performed by, a fraud detection apparatus as described with reference to FIGS. 1 and 2. In some examples, the fraud detection apparatus identifies the transaction history by accessing the blockchain of the NFT. In some examples, the fraud detection apparatus identifies the transaction history from the exchange that lists the NFT.

At operation 610, the system generates a transaction graph based on the transaction data, where the transaction graph includes nodes corresponding to blockchain addresses and nodes corresponding to individual NFTs. In some cases, the operations of this step refer to, or canare performed by, a graph component as described with reference to FIG. 2. Examples of the transaction graph include a trader-trader network and a trader-NFT network. Examples of a trader-trader network and a trader-NFT network are described with reference to FIGS. 3 and 4, respectively.

At operation 615, the system identifies a cycle of the transaction graph. In some cases, the operations of this step refer to, or are performed by, a cycle component as described with reference to FIG. 2. Additional detail regarding methods for identifying a cycle will be described with reference to FIG. 7.

At operation 620, the system predicts a fraudulent activity based on the cycle using a machine learning model. In some cases, the operations of this step refer to, or are performed by, the machine learning model with reference to FIG. 2. In an example, the system extracts fraud indicator features. These are metrics that characterize an NFT in the context of the exchange activity. Additional detail regarding the fraud indicator features will be described with reference to FIG. 7.

At operation 625, the system transmits an alert indicating the predicted fraudulent activity. In some cases, the operations of this step refer to, or are performed by, a user interface as described with reference to FIG. 1. In one example, the system provides the alert to a backend of the NFT exchange, which then displays the alert to a user through a web portal to the exchange. In at least one embodiment, the alert includes a credibility score that indicates how trustworthy an NFT or a seller is. For example, a low credibility score can indicate that the NFT or the seller is likely involved in fraudulent activity.

FIG. 7 shows an example of a method 700 for extracting non-intersecting cycles according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. The non-intersecting cycles and features thereof can be used to identify wash trading fraudulent activities.

Wash trading is a method that is used to artificially increase the exchange rate of an NFT. The following describes an illustrative example of wash trading. Let traders s1, s2, s3, and s4 belong to a colluding party. The traders will aim to artificially increase an NFT's exchange rate. In this example, a series of transactions is: p1→s1→s2→s3→s4→s1→p2, where p1 and p2 are traders with no knowledge of the colluding party.

In this sample, trader s1 buys an NFT from p1 for 100 ETH (Ethereum). Traders s2, s3, and s4 then buy the same NFT for increasing amounts in succession, at which point trader s4 purchases the NFT for 500 ETH. In this case, traders outside of the colluding party could think that the NFT is truly valued around 500 ETH, and might bid around this exchange rate. The colluding party has successfully artificially inflated the exchange rate by wash trading, and using the cycle s1→s2→s3→s4→s1.

Method 700 describes an algorithm for identifying non-intersecting cycles, i.e. cycles that begin and end on the same node, but otherwise do not visit the same node within the chain multiple times. In some cases, method 700 uses information from the trader-NFT network described above with reference to FIG. 3. In some cases, method 700 uses a transaction history. An embodiment of method 700 references a data object referred to as “node_map” which includes a list of all transactions for each NFT in the exchange in a sorted manner. In some cases, the algorithm creates a data object “cycle_list” which aggregates all non-intersecting cycles based off the transaction history. In some cases, the data object additionally includes other data such as loop length, exchange rate change (e.g., from the beginning to the end of the cycle), the trader who begins and ends the cycle, and the time gap from the beginning to the end of the cycle.

In some embodiments, method 700 is performed by a cycle component as described with reference to FIG. 2. In some embodiments, method 700 is performed on training data during a training phase to identify the most salient features that are indicative of fraudulent activity, i.e. fraud indicator features. In one example, the cycles extracted from the training data indicated that the vast majority of traders are involved in very short length cycles, which indicates that the traders involved in wash trading engage in cycles of small length.

Accordingly, one fraud indicator feature for an NFT is a “harmonic sum of length of cycles”. This feature is the harmonic sum of lengths of each cycle of an NFT. Since smaller cycles are indicated for fraudulent activity, this feature sums the inverse of the lengths. In one example, a larger value of the harmonic sum indicates a higher probability that the NFT is involved in fraudulent activity. Since lower lengths result in a smaller denominator for the inverse value, the harmonic sum will have a relatively large value when there are many cycles of small length.

Another fraud indicator feature enabled by method 700 is a “number of cycles”. The value of this feature for a given NFT is the number of cycles the NFT has participated in. If the NFT has participated in a large number of cycles, there is a higher probability that the NFT is involved in fraudulent activity, such as wash trading.

Additional fraud indicator features are computed using a transaction component, such as the one described with reference to FIG. 2. There are some fraudulent activities that can be conducted while avoiding the cycles identified by method 700. Accordingly, a transaction component is configured to identify other features related to rapid series of transactions. In some embodiments, the transaction component extracts the features from graphs created by the graph component. In some embodiments, the transaction component extracts the features from a transaction history.

Bad actors can perform money laundering by initiating a fast series of transactions within a small time gap, e.g. less than 12 hours. The series of transactions related to money laundering typically entails a low-exchange rate change of the NFT that's involved. For example, colluding parties might not be interested in inflating the exchange rate, as the final transaction also is intended to also be between colluding parties. Fraud indicator features that are extracted by the transaction component are laid out in Table 2 below.

TABLE 2
Transaction features extracted by transaction component.

| Associated Component | Fraud indicator Feature |
|---|---|
| transaction component | Number of rapid series of transactions for an |
| | NFT |
| transaction component | Length of rapid series of transactions (e.g., |
| | mean length of all rapid series for the NFT) |
| transaction component | Ratio of rapid series of transactions = |
| | (Length of series)/(Total number of |
| | transactions) |
| transaction component | Severity score |

The above features are also fraud indicator features, and can indicate whether or not a given NFT is involved in money laundering fraudulent activities. The severity score is a measure of how likely a given series of rapid transactions for an NFT is related to fraudulent activity, and is calculated by the following:

$$Severity Score = \frac{Length of series}{( ( 0.01 + \vert Price change \% \vert ) * ( Time gap + \frac{1}{3600} ) )} \qquad ( 1 )$$

Accordingly, a transaction component as described with reference to FIG. 2 is configured to identify the extent to which an NFT is involved in money laundering on an NFT exchange. In some embodiments, the severity score is combined with an outputs from the cycle component to generate a total score indicating the extent the NFT is involved in multiple different fraudulent activities.

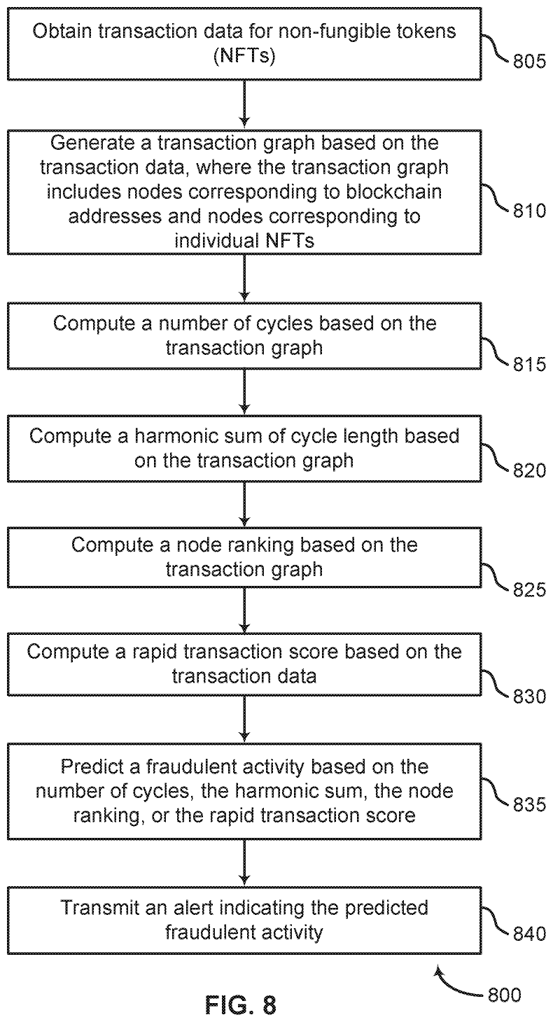

FIG. 8 shows an example of a method 800 for predicting fraudulent activity based on multiple fraud indicator features according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains transaction data for non-fungible tokens (NFTs). In some examples, the fraud detection apparatus as described with reference to FIGS. 1 and 2 identifies the transaction history by accessing the blockchain of the NFT. In some examples, the fraud detection apparatus identifies the transaction history from the exchange that lists the NFT.

At operation 810, the system generates a transaction graph based on the transaction data, where the transaction graph includes nodes corresponding to blockchain addresses and nodes corresponding to individual NFTs. In some cases, the operations of this step refer to, or are performed by, a graph component as described with reference to FIG. 2. Examples of the transaction graph include a trader-trader network and a trader-NFT network. Examples of a trader-trader network and a trader-NFT network are described with reference to FIGS. 3 and 4, respectively.

At operation 815, the system computes a number of cycles based on the transaction graph. The number of cycles can be the number of non-intersecting cycles that a selected NFT is involved in. In some cases, the system computes the number of cycles based on a transaction history. In some cases, the operations of this step refer to, or are performed by, a cycle component as described with reference to FIG. 2. Embodiments of the cycle component are configured to perform a method to extract the non-intersecting cycles such as the one described with reference to FIG. 7.

At operation 820, the system computes a harmonic sum of cycle length based on the transaction graph. In some cases, the operations of this step refer to, or are performed by, a cycle component as described with reference to FIG. 2. In at least one embodiment, the cycle component computes the harmonic sum of cycle length based on a transaction history which is encoded outside of the transaction graph.

At operation 825, the system computes a node ranking based on the transaction graph. In some cases, the operations of this step refer to, or are performed by, a ranking component as described with reference to FIG. 2. The node ranking can include one or more of the features listed in Table 1.

At operation 830, the system computes a rapid transaction score based on the transaction data. In some cases, the operations of this step refer to, or are performed by, a transaction component as described with reference to FIG. 2. The transaction score can be the severity score as described with reference to Table 2, or can also include one or more of the other features described with reference to Table 2.

At operation 835, the system predicts a fraudulent activity based on the number of cycles, the harmonic sum, the node ranking, or the rapid transaction score. At operation 840, the system transmits an alert indicating the predicted fraudulent activity. In an example, the system provides the alert to a backend of the NFT exchange, which then displays the alert to a user through a web portal to the exchange. In at least one embodiment, the alert includes a credibility score that indicates how trustworthy an NFT or a seller is. For example, a low credibility score indicates that the NFT or the seller is likely involved in fraudulent activity.

### Training

A method for identifying fraudulent activity in NFT exchanges is described. One or more aspects of the method include obtaining training data including transaction data for non-fungible tokens (NFTs); generating a transaction graph based on the transaction data, wherein the transaction graph includes nodes corresponding to blockchain addresses and nodes corresponding to individual NFTs; identifying a cycle of the transaction graph; and training a machine learning model to predict a fraudulent activity based on the cycle and the training data.

Some examples of the method, apparatus, non-transitory computer readable medium, and system further include dividing the transaction data into a first period and a second period, wherein the machine learning model is trained based on the transaction data from the first period and is evaluated based on the transaction data from the second period. Some examples of the method further include training the machine learning model to predict an NFT exchange rate based on the training data. In some aspects, the machine learning model is trained based on a causal forest learning method.

FIG. 9 shows an example of a method 900 for training a machine learning model to predict fraudulent activity according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains training data including transaction data for non-fungible tokens (NFTs). In some cases, the operations of this step refer to, or are performed by, a fraud detection apparatus as described with reference to FIGS. 1 and 2. In some cases, the training data includes a transaction history spanning a length of time, such as a month, for all traders and NFTs on an NFT exchange.

At operation 910, the system generates a transaction graph based on the transaction data, where the transaction graph includes nodes corresponding to blockchain addresses and nodes corresponding to individual NFTs. In some cases, the operations of this step refer to, or are performed by, a graph component as described with reference to FIG. 2. Examples of the transaction graph include a trader-trader network and a trader-NFT network. Examples of a trader-trader network and a trader-NFT network are described with reference to FIGS. 3 and 4, respectively.

At operation 915, the system identifies a cycle of the transaction graph. In some cases, the operations of this step refer to, or are performed by, a cycle component as described with reference to FIG. 2. In some examples, the cycle is the number of cycles that a selected NFT is involved in, the harmonic sum of cycle lengths (or inverse cycle lengths), or a combination thereof.

At operation 920, the system trains a machine learning model to predict a fraudulent activity based on the cycle and the training data. In some cases, the operations of this step refer to, or are performed by, a training component as described with reference to FIG. 2. In some cases, the machine learning model is trained to predict the fraudulent activity based on one or more of the fraud indicator features described herein, such as the cycle features or the transaction features.

In some embodiments, the machine learning model is trained to fit a regression model to predict the future exchange rate of NFTs. In some embodiments, the regression model is trained based on the network level features described with reference to Table 1.

Embodiments of the system additionally compute average treatment effects (ATEs) for each of the fraud indicator features. Some embodiments of the system include a machine learning model that implements a causal forest model.

Causal forests are an adaptation of the random forest algorithm. Causal forests are used to determine the differences in influences of various treatment variables on an outcome variable. For example, treatment variables can include the fraud indicator features described herein, such as the number of cycles for an NFT and the harmonic sum of (inverse) cycle length for an NFT, and the outcome variable can be the exchange rate of an NFT.

In some embodiments, the training of the machine learning model includes training parameters of the causal forests to the training data. Before the parameters are learned, the causal model is fit to the data, which includes choosing values for the hyperparameters of the causal forests, such as “maximum tree depth,” “maximum number of samples,” and “number of estimators.” Then the parameters are learned from the training data. For example, the relationship between the fraud indicator features and the changes in the NFT exchange rate is learned while the causal forest captures this relationship as well as the difference in ATE for each feature.

In an embodiment, the system learns that the harmonic sum of (inverse) cycle length in combination with the number of cycles has the largest ATE. The system additionally learns that the harmonic sum of (inverse) cycle length alone has a larger ATE than the number of cycles alone. Accordingly, the system adjusts the fraud indication to the user by weighting the values of these features for a selected NFT. In some cases, the fraud indication includes a credibility score that indicates the credibility of the NFT as described above.

In some embodiments, the ATEs for each fraud indicator feature discovered by the system are used to estimate an exchange rate of the NFT supposing the effects of fraudulent activity are removed. In at least one embodiment, the system provides a “corrected exchange rate” to the user by setting the treatment variables (fraud indicator features) for the selected NFT to zero values in the causal forest model.

FIG. 10 shows an example of a computing device 1000 configured to identify fraud in NFT exchanges according to aspects of the present disclosure. The example shown includes computing device 1000, processor(s) 1005, memory subsystem 1010, communication interface 1015, I/O interface 1020, user interface component(s), and channel 1030.

In some embodiments, computing device 1000 is an example of, or includes aspects of, fraud identification apparatus 100 of FIG. 1. In some embodiments, computing device 1000 includes one or more processors 1005 that can execute instructions stored in memory subsystem 1010 to obtain transaction data for NFTs; generate a transaction graph based on the transaction data, wherein the transaction graph includes nodes corresponding to blockchain addresses and nodes corresponding to individual NFTs; identify a cycle of the transaction graph; predict a fraudulent activity based on the cycle using a machine learning model; and transmit an alert indicating the predicted fraudulent activity.

According to some aspects, computing device 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component(s) 1025 enable a user to interact with computing device 1000. In some cases, user interface component(s) 1025 include an audio device, such as an external speaker system, an external display device such as a display screen, an input device (e.g., a remote control device interfaced with a user interface directly or through the I/O controller), or a combination thereof. In some cases, user interface component(s) 1025 include a GUI.

The description and drawings described herein represent example configurations and do not represent all the implementations within the scope of the claims. For example, the operations and steps can be rearranged, combined or otherwise modified. Also, structures and devices can be represented in the form of block diagrams to represent the relationship between components and avoid obscuring the described concepts. Similar components or features can have the same name but can have different reference numbers corresponding to different figures.

Some modifications to the disclosure are readily apparent to those skilled in the art, and the principles defined herein can be applied to other variations without departing from the scope of the disclosure. Thus, the disclosure is not limited to the examples and designs described herein, but is to be accorded the broadest scope consistent with the principles and novel features disclosed herein.

In some examples, the described methods are implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A “general-purpose processor” includes a microprocessor, a conventional processor, controller, microcontroller, or state machine. A processor can also be implemented as a combination of computing devices (e.g., a combination of a DSP and a microprocessor, multiple microprocessors, one or more microprocessors in conjunction with a DSP core, or any other such configuration). Thus, the functions described herein can be implemented in hardware or software and can be executed by a processor, firmware, or any combination thereof. If implemented in software executed by a processor, the functions can be stored in the form of instructions or code on a computer-readable medium.

Computer-readable media includes both non-transitory computer storage media and communication media including any medium that facilitates transfer of code or data. A non-transitory storage medium can be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components can be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” can be based on both condition A and condition B. In other words, the phrase “based on” shall be construed to mean “based at least in part on.” Also, the words “a” or “an” indicate “at least one.”

What is claimed is:

1. A method comprising:
obtaining transaction data for non-fungible tokens (NFTs);
generating, using a graph component, a transaction graph based on the transaction data, wherein the transaction graph includes nodes corresponding to blockchain addresses and nodes corresponding to individual NFTs;
identifying, using a cycle component, a cycle of the transaction graph;
predicting, using a machine learning model, a fraudulent activity based on the cycle; and
transmitting an alert indicating the predicted fraudulent activity.

2. The method of claim 1, further comprising:
generating, using the graph component, an edge of the transaction graph between a first node corresponding to a first blockchain address and a second node corresponding to a second blockchain address based on a transfer of an NFT from the first blockchain address to the second blockchain address.

3. The method of claim 1, further comprising:
generating, using the graph component, an edge of the transaction graph between a first node corresponding to a first blockchain address and a second node corresponding to an NFT based on a transfer of the NFT to or from the first blockchain address.

4. The method of claim 1, further comprising:
computing, using the cycle component, a number of cycles based on the transaction graph, wherein the fraudulent activity is predicted based on the number of cycles.

5. The method of claim 1, further comprising:
computing, using the cycle component a harmonic sum of cycle length based on the transaction graph, wherein the fraudulent activity is predicted based on the harmonic sum of cycle length.

6. The method of claim 1, further comprising:
computing, using a ranking component, a node ranking based on the transaction graph, wherein the fraudulent activity is predicted based on the node ranking.

7. The method of claim 1, further comprising:
computing, using a transaction component, a rapid transaction score based on the transaction data, wherein the fraudulent activity is predicted based on the rapid transaction score.

8. The method of claim 1, further comprising:
predicting, using the machine learning model, a value of an NFT based on the transaction data.

9. The method of claim 1, further comprising:
limiting transactions on an NFT trading platform based on the predicted fraudulent activity.

10. The method of claim 1, further comprising:
performing a transaction on a blockchain based on the predicted fraudulent activity.

11. A method comprising:
obtaining training data including transaction data for non-fungible tokens (NFTs);
generating, using a graph component, a transaction graph based on the transaction data, wherein the transaction graph includes nodes corresponding to blockchain addresses and nodes corresponding to individual NFTs;
identifying, using a cycle component, a cycle of the transaction graph; and
training, using a training component, a machine learning model to predict a fraudulent activity based on the cycle and the training data.

12. The method of claim 11, further comprising:
dividing, using the training component, the transaction data into a first period and a second period, wherein the machine learning model is trained based on the transaction data from the first period and is evaluated based on the transaction data from the second period.

13. The method of claim 11, further comprising:
training, using the training component, the machine learning model to predict an NFT exchange rate based on the training data.

14. The method of claim 11, wherein:
the machine learning model is trained based on a causal forest learning method.

15. An apparatus comprising:
at least one processor;
at least one memory including instructions executable by the at least one processor;
a graph component configured to generate a transaction graph based on transaction data, wherein the transaction graph includes nodes corresponding to blockchain addresses and nodes corresponding to individual non-fungible tokens (NFTs);
a cycle component configured to identify one or more cycles in the transaction graph;
a machine learning model including parameters stored in the at least one memory and configured to predict fraudulent activity based on the one or more cycles; and
a user interface configured to transmit an alert based on the prediction, wherein the alert indicates the predicted fraudulent activity.

16. The apparatus of claim 15, further comprising:
a training component configured to train the machine learning model to predict the fraudulent activity based on the cycle.

17. The apparatus of claim 15, further comprising:
a transaction component configured to compute a rapid transaction score based on the transaction data.

18. The apparatus of claim 15, further comprising:
a ranking component configured to predict a node ranking of a node in the transaction graph, based on the transaction graph.

19. The apparatus of claim 15, wherein:
the machine learning model is trained to predict an NFT exchange rate.

20. The apparatus of claim 15, wherein:
the cycle component is configured to compute a number of cycles, a harmonic sum of cycle length, or a combination thereof based on the transaction graph.
